(19) United States
(12) Patent Application Publication
(10) Pub. No.: US 2009/0080285 A1
(43) Pub. Date: Mar. 26, 2009

(54) Processor

(75) Inventors: John C. Brotz, Newton, NH (US); Ryan C. Scribner, Cambridge, MA (US); Tamimu A. Shyllon, Randolph, MA (US); Mary T. Sarich, Wilmington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Proteus Design, Inc., Cambridge, MA (US)

(21) Appl. No.: 11/904,323

(22) Filed: Sep. 26, 2007

(51) Int. Cl. B01F 7/00

(52) U.S. Cl. 366/272; 366/331; 366/289

(57) ABSTRACT

An appliance configured to process food includes a primary motor and a secondary motor. The primary motor is configured to rotate a blade connected to a spindle and the blade and the spindle are positioned above a blade platform. The primary motor is mounted on a second platform. The second motor is configured to translate the blade platform and the spindle by a first linkage from a first position to a second position relative to the second platform.

### BACKGROUND

Mixing devices that provide a rotational movement and also a vertical or oscillatory motion are known in the art. One example of such a device that provides rotational movement and also vertical and oscillatory motion is U.S. Pat. No. 5,150,967 to Neilson, et al. (hereinafter “Neilson”). Neilson discloses a milk shake mixing machine that includes a first motor and a second motor for vertical or oscillatory motion.

### SUMMARY OF THE INVENTION

There is a need for a mixing device that can provide both vertical, oscillatory motion and rotational motion without limiting the RPM rating and/or torque of both motors. According to a first aspect of the present disclosure there is provided an appliance. The appliance has a primary motor that is configured to rotate a blade connected to a spindle. The blade and the spindle are disposed on a blade platform and the primary motor is mounted on a second platform. A second motor is configured to translate the blade platform and the spindle by a first linkage from a first position to a second position relative to the second platform. In another aspect, the first motor and the second motor are independent from one another. In yet another aspect, the appliance further has a first output shaft. The first output shaft is connected to the spindle and the spindle is connected to a spindle head. The spindle head is configured to rotate a plurality of blades with the first output shaft connected to the primary motor.

In a further aspect, the blade platform includes an aperture and the spindle is positioned through the aperture and configured to rotate the blade above the blade platform.

In another embodiment, the second motor includes an output shaft. The output shaft is connected to a geared arrangement to move a first linkage in a longitudinal manner. The first linkage includes a rocker arm. The rocker arm has a first end configured to rotate and a second lever end configured to longitudinally reciprocate between an elevated and a lowered position.

In another aspect, the second lever end is connected to the first linkage and the first linkage is connected to the blade platform by a pin. In another aspect, the appliance further includes a container. The container is disposed above the second or blade platform. In another aspect, the appliance includes a number of blades. In yet another embodiment, the geared arrangement can include a first gear that has a plurality of teeth connected to a second gear. The second gear further is configured to reciprocate the first linkage from the first position to the second position by reciprocating a rocker arm.

According to another aspect of the present disclosure, the geared arrangement may include a second gear. That second gear is connected to a first cam and the first cam is connected to a first end of an intermediate linkage. The intermediate linkage rotates the first end. The intermediate linkage also includes a second end that is opposite the first end with a second end being configured to move the rocker arm in a longitudinal manner in response to the rotation. In another embodiment, the container is suspended above the first platform.

In another embodiment, there is provided an appliance. The appliance includes a primary motor configured to rotate a blade disposed above a first platform with the primary motor being stationary and connected to a second stationary platform. The first platform is disposed above the second platform. The appliance also has a second motor independent of the primary motor. The second motor is operatively connected to the first platform by a first linkage, which is connected to a rocker arm.

The second motor operates to move the rocker arm connected to the first linkage. The rocker arm moves the first linkage in response to the rotation. The rocker arm reciprocates the first platform relative to the second platform from a first elevated position to a second lowered position. The second motor includes an output shaft. The output shaft is connected to a sun gear. The sun gear is connected to a planet gear. The sun gear rotates the planet gear to rotate a first cam. The first cam is connected to a second linkage and the second linkage rotates the rocker arm.

The first linkage further includes a second end connected to a pivot, and the pivot is connected to the first platform. Rotation of a first end of the first linkage, connected to the rocker arm, reciprocates the second end in a longitudinal manner. This elevates and lowers the first platform relative to the second platform. The appliance can also have the blade supported on a spindle. The spindle extends through an aperture in the first platform. The spindle rotates relative to the first platform. It should be appreciated that the first platform does not spin with the spindle. A bearing may be provided to permit the spindle to rotate while the first platform moves upwardly, and downwardly.

In yet another embodiment of the present disclosure, the appliance includes a primary motor that is configured to rotate a blade disposed above a first platform. The primary motor is stationary and connected to a second platform. The first platform is located above the second platform. A second motor independent of the primary motor is operatively connected to the first platform by a first linkage. The primary motor rotates the blade disposed above the first platform. The second motor rotates a second linkage connected to the first linkage. The first linkage, in response to the rotation, is configured to reciprocate the first platform relative to the stationary second platform, or between a first elevated position and a second lowered position.

In a further embodiment of the present disclosure, the appliance has a first motor that includes a first output shaft connected to a spindle. The spindle is connected to a spindle head. The spindle head is configured to rotate a plurality of blades and the appliance also has a blade platform. The platform includes an aperture. The spindle extends above the aperture and is configured to rotate the plurality of blades above the blade platform. The appliance also has a second motor that is stationary and connected to a second platform.

The second platform is positioned under the blade platform. The second motor includes a second output shaft and the second output shaft is connected to a first gear. The first gear is rotatably connected to a second gear. The second gear is also connected to a first cam. The first cam is operatively connected to a first linkage at a first end and the first linkage is connected to a rocker arm. In this embodiment, the second motor operates to rotate the second output shaft to rotate the first gear. The first gear rotates the second gear and the second gear rotates the first linkage. The first linkage rotates the rocker arm and the rocker arm is connected to a second linkage. The second linkage has a first end and a second end. The first end, in response to the rotation, moves the second end in a longitudinal direction. The second linkage is connected to the blade platform at the second end and is configured to reciprocate the blade platform in a longitudinal manner relative to the second platform, or between a first position and a second position.

In another embodiment, the apparatus further has a post connected on the second platform. The post can be disposed through the blade platform. The post orients the blade platform during movement of the blade platform from the first position to the second position. It should be appreciated that the post is optional, and the blade platform may move without an orientation or guide post. In another embodiment, the apparatus has the post supporting a container. The apparatus can further include a secondary linkage connected to the blade platform on an opposite side. This secondary linkage may be configured to translate the blade platform from the first position to the second position.

According to yet another aspect of the present disclosure, there is provided an appliance that has a motor, which is configured to rotate a blade disposed above a first platform. The motor includes a first rotatable shaft and a second rotatable shaft. The second rotatable shaft extends opposite the first rotatable shaft. The motor also has a blade connected to the first rotatable shaft. The appliance further has a worm gear positioned over the second rotatable shaft. The appliance also has a gear that engages the worm gear.

A cam is connected to the gear, and a linkage connects the cam to the first platform. In operation, the motor rotates the worm gear, and the worm gear rotates the gear. The gear is configured to rotate about the cam, and the gear moves a second linkage. The second linkage moves the motor to translate the blade upwardly and downwardly. The second linkage preferably moves the entire motor vertically, and this translates the blade, which is connected to the drive shaft, upwardly and downwardly, and in a cyclic manner. Preferably, the motor is vertically moved in the cyclic manner, which is based on the rotation of the worm gear. A post can also be provided, which is connected to a stationary platform. The post assists with guiding the motor. A resilient looped member can be connected to the motor to assist with engaging the post, and to guide the motor.

In another embodiment, the appliance can have multiple posts connected to a stationary platform, and multiple loops connected to the motor. Each loop preferably engages each post supported on the platform to assist with guiding the motor. Multiple blades can also be connected to the first rotatable shaft. In one embodiment, the cam can be connected to the gear by a third linkage. The cam is preferably located at an end of the linkage. The cam is connected to the third linkage preferably by a pin. The linkage can also be connected to the first platform by a pin.

The motor is preferably lightweight and conducive to moving upwardly and downward, but also has sufficient power for chopping and grating. The worm gear can be positioned over the second rotatable shaft, and may include a spiral shaped groove that engages with teeth on the gear. The linkage (connecting the cam to the first platform) preferably is a bar-like resilient member. The appliance may also include a housing with a container connected to the housing, and preferably the blade extends into the container for processing food. The motor rotates the worm gear in a first rotational direction, and the worm gear rotates the gear. In response, the gear is configured to rotate about the cam in a second rotational direction with the gear moving the second linkage in a cyclic, and vertical manner. The first rotatable shaft extends from a top of the motor, and the second rotatable shaft extends from a bottom of the motor. The first rotatable shaft extends above the first platform through a sealed aperture. The worm gear is disposed in a generally coaxial manner over the second rotatable shaft.

According to another aspect of the present disclosure, there is provided an appliance that includes a movable motor configured to rotate a blade disposed above a first platform. The motor includes a first rotatable shaft and a second rotatable shaft. The second shaft extends opposite the first rotatable shaft. A blade is connected to the first rotatable shaft.

A worm gear is disposed coaxial over the second rotatable shaft. A gear engages the worm gear. A cam surface is connected to the gear by a first link. The cam surface includes a second link connecting the cam surface to the first platform so the cam surface remains stationary relative to the moveable motor.

In operation, the motor rotates the worm gear, and rotates the gear. The gear is configured to rotate about the cam surface, and the gear moves a third link. The third link is connected to the motor. The third link moves the motor to translate the blade upwardly and downwardly based on the rotation of the worm gear.

In yet another aspect, there is provided a method of moving a blade of an appliance in an oscillating, rotating, and cyclic motion. The method includes providing a motor includes a first rotating shaft, and a second opposite rotating shaft. The method also includes providing a blade on the first rotating shaft, and rotating the blade using the first rotating shaft. The method further provides a stationary cam surface and translates rotation from the second opposite rotating shaft to the stationary cam surface to move the motor vertically, and in a cyclic manner. The motor, in turn, moves the rotating blade vertically.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a perspective view of a first embodiment of a food processor.

FIG. 2 is a side view of the food processor showing the first and second motors.

FIG. 3 shows operation of the rocker arm to move the first linkage in the direction of reference arrows B and C.

FIG. 4 shows a lateral side view of the food processor of FIG. 1 having an axle with a third linkage connected to the blade platform.

FIG. 5 shows a cross sectional view taken along line 5-5 of FIG. 3 of the food processor of FIG. 1 having a primary motor connecting to the spindle.

FIG. 6 shows a canister according to one embodiment of the present disclosure.

FIG. 7 shows a perspective view of another embodiment of a food processor with a vertically moving motor.

FIG. 8 shows a side view of a worm gear connected to a gear to drive the motor;

FIG. 9 shows another side view of the appliance of FIG. 8.

FIG. 10 shows yet another side view of the motor including a loop for connecting to a guide post that is connected to the stationary platform.

### DETAILED DESCRIPTION

A description of example embodiments of the invention follows.

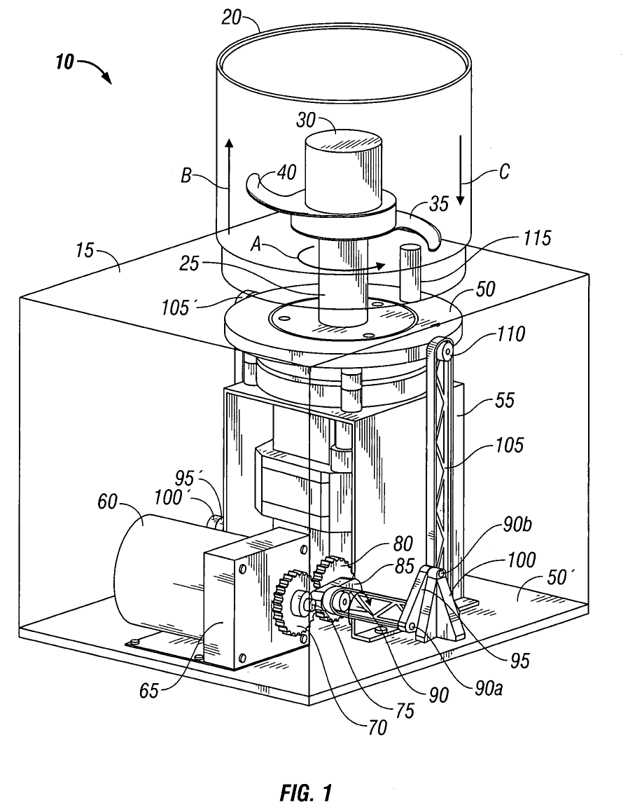

Turning now to FIG. 1 there is shown a food processor 10 according to an embodiment of the present invention. The food processor 10 includes a housing 15 which is generally rectangular in shape. A food processing canister 20 is disposed on the top of the housing 15 and food may be introduced into the food processing canister 20 through a top side of the food processing canister 20. It should be appreciated that the present appliance 10 is not limited to a food appliance and can be applied to any mixing, processor, blender, stand mixers, or sanding equipment. The food processing canister 20 can be made from a lightweight inexpensive material with a safety device (not shown) as is known in the art to protect the user when inserting food into the canister 20. The food processing canister 20 is removable and is where chopping dicing, and slicing of the deposited food occurs. The food processor 10 also has a spindle 25 that extends longitudinally into the food canister 20. The spindle 25 is connected to a blade cap 30. The blade cap 30 is generally cylindrical and is placed on the top of the spindle 25. The food processor 10 also includes a first blade 35 and a second blade 40 that extend horizontally from the blade cap 30 to provide chopping, grating, or slicing. The first and second blades 35, 40 can preferably be made from a thermoplastic, metal, titanium, aluminum, or an alloy and are suitably strong and resilient for both rotational and vertical motion. The blades 35, 40 preferably rotate in the food processing canister 20 as indicated by reference arrow A to cut, slice, grate or process food inside the food processing canister 20. Although two blades 35,40 are shown, it is envisioned that the food processor 20 may be made with three or more blades or a single blade. Various blade configurations are possible and within the scope of the present disclosure.

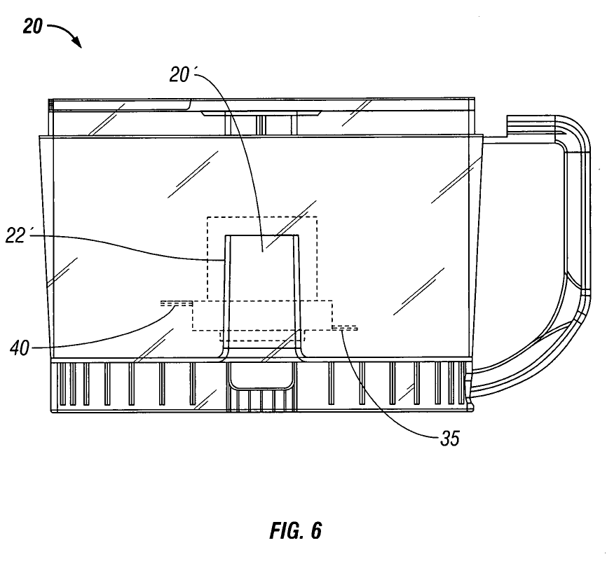

As shown in FIG. 6, the canister 20 includes a center hole 20′, with a full rim 22′. The blades 35, 40 (shown in phantom) come down over the rim 22′. This arrangement keeps food from falling out of the bowl. A seal may also be provided between spindle 35 and the remainder of the housing 10 to ensure that particles do not fall into the housing 10.

Turning again to FIG. 1, the food processor 10 according to the present description also includes a blade platform 50. The blade platform 50 is generally disk shaped to fit and move vertically with respect to the food processing canister 20 inside the canister 20. The blade platform 50 advantageously can move in a vertical manner relative to the horizontal or upward as indicated by reference arrow B and downward as indicated by reference arrow C in a repeated and cyclic manner at a predetermined frequency that is beneficial to chop food. This movement occurs while the food processing canister 20 remains stationary to provide for both rotational movement and vertical movement of the blades 35, 40. Movement in directions A, B, and C provides for advantageous operation of the food processor 10 since the blades 35, 40 can rotate in the direction of reference arrow A for chopping. Thereafter, the user can control the food processor 10 for vertical motion to improve operation. While rotating in the direction of reference arrow A, the blades 35, 40 can also move in the direction of reference arrows B and C to further provide chopping action and/or advantageous grating or slicing of the foods inside food processing canister 20. This is accomplished in an advantageous manner since the amount of revolutions per minute of the blades 35, 40 is sufficiently fast to provide for a high torque rotational motion. Since motor 55 can remain stationary and does not need to be moved, motor 55 having high torque can be used to rotate the blades 35, 40.

Turning to the interior contents of the housing 15, which is shown in FIG. 1, there is shown operation of how the blade platform 50 moves relative to a stationary platform 50′. Preferably, the stationary platform 50′ is a relatively thick support member that rests on a countertop or similar lateral surface to provide horizontal support to the food processor 10 while the blade platform 50 moves in the direction of reference arrow B and C relative to the stationary platform 50′ in a cyclic manner. Platform 50′ can be metal, plastic or other material and can form part of the housing 15. As shown in the interior view of FIG. 1, or inside the housing 15, the food processor 10 includes a primary motor 55. The primary motor 55 is connected to the stationary platform 50′ and remains stationary throughout the operation of the food processor 10. This is advantageous since the blade platform 50 can move in the directions of reference arrows B and C while not having to move the mass of the primary motor 55 for rotation of the blades 35, 40 in the direction of reference arrow A. This advantageous feature of the food processor 10 may permit for relatively larger motors 55 to be used in connection with the food processor 10 that have significant drive output to rotate the blades 35, 40 in the rotational direction A. This can provide for an increased rate of rotation of blades 35, 40 for increased chopping, slicing, or grating action.

Operation of the blade platform 50 and, in particular movement in the direction of reference arrows B and C, will now be shown and described. In one aspect, blade platform 50 is moved using an independent power source exclusive of motor 55. Turning to the interior contents of the housing 15, the food processor 10 includes a second motor 60. The second motor 60 can be a similar or different type of motor relative to the primary motor 55, and is preferably disposed horizontally on the stationary platform 50′. The second motor 60 can be disposed through a block-like support structure 65 that is fixedly supported on the stationary platform 50′, or using an L-shaped bracket 65. The second motor 60 preferably outputs rotational movement that is converted to the longitudinal movement of the blade platform 50 in the direction of reference arrows B and C. Preferably, the rotational movement is converted using a geared arrangement.

In this aspect, the second motor 60 includes a sun gear 70. The second motor 60 is preferably connected to the sun gear 70 by a motor output drive shaft 75 with the drive shaft 75 extending through the sun gear 70. Motor 60 preferably can be a switched reluctance motor, or any suitable electric motor known in the art. It should be appreciated that the motor 60 may be connected to a different or the same switch (not shown) relative to motor 55. Preferably, the second motor 60 is electrically coupled to a power source (not shown) and the second motor 60 can spin or rotate the sun gear 70 in a clockwise or counterclockwise fashion when energized with power. The second motor 60 spins the sun gear 70 in a clockwise or counterclockwise fashion by rotating the motor output shaft 75 upon being energized from the power source. Various rotational configurations are possible and within the scope of the present invention.

The food processor 10 also includes a planet gear 80. The planet gear 80 is disposed offset relative to the sun gear 70, which is coupled to the second motor 60, such that the teeth of the sun gear 70 mesh with the teeth of the planet gear 80 and rotational movement from motor 60 is communicated to the planet gear 80. In this manner, upon being energized, the second motor 60 will spin the sun gear 70 using a motor output drive shaft 75 and, the spinning teeth will engage the teeth of the planet gear 80. This will drive the planet gear 80 in an opposite direction relative to the rotation of the sun gear 70. The planet gear 80 is further connected to a first cam 85 using a pin (not shown) or other suitable connection member. The first cam 85 is preferably rotationally connected to the planet gear 80 and rotates in a similar manner. In this manner, upon the planet gear 80 being rotated, the first cam 85 will also be rotated in the similar rotational manner and direction.

The food processor 10 further includes a first linkage 90. The first linkage 90 is a bar like resilient member that operates as a member to connect first cam 85 to a rocker arm 95. The first linkage 90 is rotationally connected to the first cam 85 or fastened to an outside of the first cam 85. Upon the first cam 85 rotating, the first linkage 90 will rotate in a similar manner or rotate in a direction along its longitudinal axis to move perpendicular relative to the output shaft 75.

The food processor 10 further includes a rocker arm 95. The first linkage 90 is connected between the first cam 85 and the rocker arm 95. The rocker arm 95 is preferably a triangular shaped member. Rocker arm 95 has a first end 90a connected to the first linkage 90 by a pin and a second end 90b that is connected to a post 100. Rocker arm 95 can rotate about the second end 90b. Post 100 is rigidly connected to the stationary platform 50′ and is stationary to provide support to rocker arm 95. The rocker arm 95 will rotate in response to the rotation of the first linkage 90. This rotation will cause an end 90c of the rocker arm 95 to move a second linkage 105 (FIG. 3). The second linkage 105 preferably moves the blade platform 50 in the vertical manner.

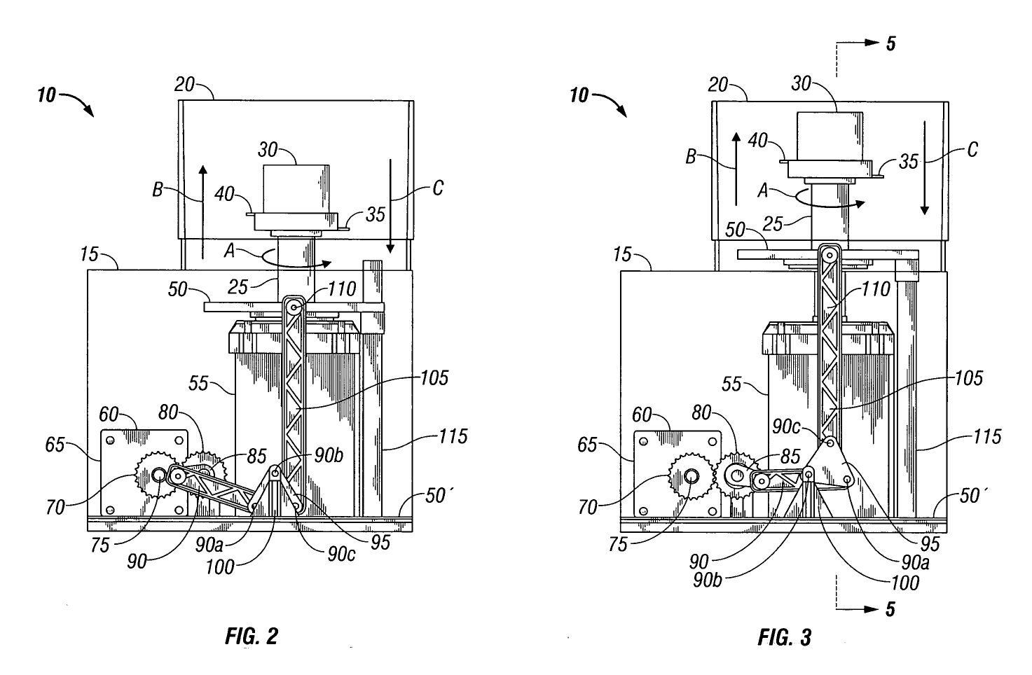

Turning now to FIG. 2 there is shown a side view of the rocker arm 95 being connected to the second linkage 105 which is connected to the blade platform 50. In FIG. 2, the blade platform 50 is shown as a cylindrical disc-shaped member. The blade platform 50 is connected at a radial edge to the second linkage 105 by a pin 110; however, it should be appreciated by one skilled in the art that the blade platform 50 may be connected to the second linkage 105 at another location, and by any manner known in the art.

The food processor 10 further includes an orientation post 115. The orientation post 115 is a cylindrical-shaped resilient member that extends upwardly from the stationary platform 50′ through the blade platform 50. Post 115 may extend through an aperture formed in the blade platform 50. It should be appreciated that the orientation post 115 does not move relative to the stationary platform 50′. Post 115 is configured to correctly orient the blade platform 50 as the blade platform 50 moves in the direction of reference arrows B and C throughout use. Post 115 also supports the food processing canister 20 in an elevated position. Post 115 is optional, and the blade platform 50 may move in the directions B, C, without a post 115.

It should be appreciated that if the device 10 is larger, other additional posts may be necessary to support the food processing canister 20.

Turning now to FIGS. 2 and 3 together, during normal operation of the food processor 10, the blades 35 and 40 will rotate in the direction of reference arrow A, or spin by the rotation of the output shaft 55′ of the primary motor 55 (FIG. 5). During rotation of second motor 60, the rocker arm 95 will be rotated by the first linkage 90. The rocker arm 95 includes a pin connection at end 90c to the second linkage 105. As the rocker arm 95 is rotated, the rocker arm 95 will move the second linkage 105 in the direction of reference arrow B as shown in FIG. 3. This will move the blade platform 50 relative to the stationary platform 50′ in a similar cyclic vertical manner. The blade platform 50 in turn will elevate spindle 25, which is supported above the blade platform 50, in the direction of reference arrow B, which moves the blade cap 30 and the first and second blades 35, 40 in the direction of reference arrow B as shown. This will occur as the blades 35,40 are rotating in the direction of reference arrow A and provides for the vertical or oscillating motion of the blades 35, 40. It should be appreciated by one of ordinary skill in the art that this may be accomplished while the primary motor 55 is held stationary and disposed on the stationary platform 50′. Thus, there is no need to move the entire primary motor 55 during the movement of the spindle 25 in the direction of reference arrows B and C.

Primary motor 55 having high torque or a high revolution per minute (“RPM”) rating can be used to provide for increased chopping action. It should be appreciated that in another embodiment, instead of a rocker arm 95, an additional gear (not shown) may be used to move the second linkage 105 for vertical motion of the blade platform 50. Various gear configurations are possible and within the scope of the present disclosure, such as a hypoid gear, a planetary gear, or any other device to convert the rotational motion of the motor 60 to vertical action of linkage 105. It should be appreciated that drive shaft 55′ of motor 55 shown in FIG. 5 may be connected to an extension 200 that permits the spindle 25 to move vertically while still turning in the direction of reference arrow A. In another embodiment, the extension 200 may be a worm gear or suitable member to permit spindle 25 to move vertically while still rotation continuously in the direction of reference arrow A.

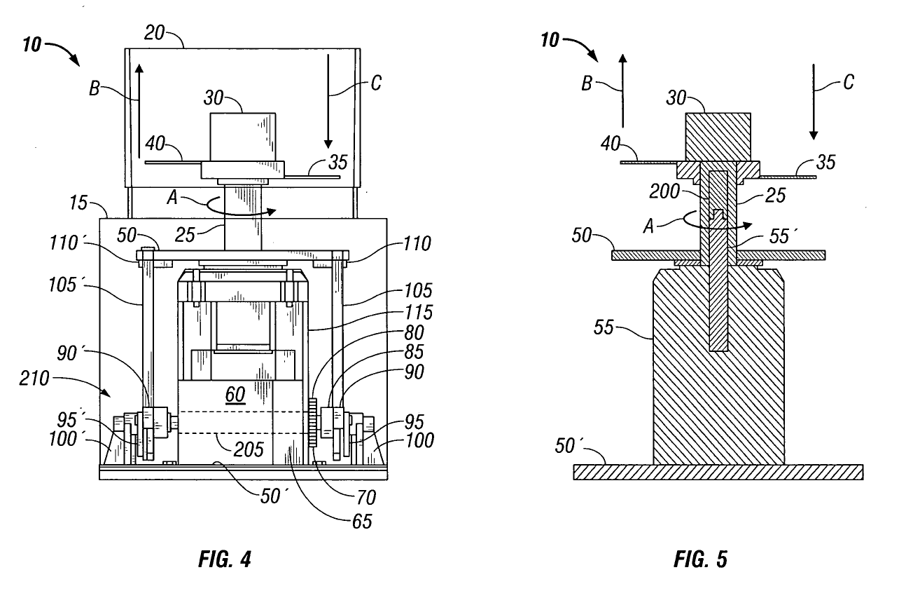

Turning now to FIG. 4 there is shown a lateral side view of the inside of the housing 15 connected to the food processing canister 20 of the food processor 10 according to the present disclosure. It should be appreciated that in this embodiment, the blade platform 50 again moves relative to the stationary platform 50′ as discussed with reference to FIGS. 1-3 in the direction of reference arrows B, C to provide both rotational and vertical movement of blades 35, 40. Likewise, the primary motor 55 is stationary and remains connected to the stationary platform 50. In this embodiment, the blade platform 50 can be connected to multiple linkages at more than one radial edge to move in the direction of arrows B, C. Additionally, the blade platform 50 can be connected to multiple linkages at different locations, and my different types of connectors, and the present disclosure is not limited to any specific location or fastener. to move in the direction of arrows B, C.

In this embodiment, the second motor 60 includes an axle 205 that is disposed parallel to the stationary platform 50′ and that is connected to the planet gear 80 as shown. In this aspect, the secondary motor 60 may rotate the sun gear 70, which in turn, rotates the planet gear 80. In response, the planet gear 80 may further be connected to the axle 205 to rotate the axle 205. Here, axle 205 rotates a secondary linkage system 210 connected to an opposite side of the blade platform 50. In this aspect, the food processor 10 includes a third linkage 105′ that is connected to the blade platform 50 by a pin 110′ at an opposite radial edge of the blade platform 50. In this manner, the rotational movement of planet gear 80 can be translated to a second planet gear (not shown) on an opposite side, which is a connected to a second rocker arm 95′ in a similar manner as described above. Second rocker arm 95′ is connected to the third linkage 105 in the same manner previously described with reference to FIGS. 1-3.

In this manner, the blade platform 50 may be supported on two or more radial sides or edges for support to move the spindle 25 which rotates the first and second blades 35, 40 in the direction of reference arrow A. Blade platform 50 may be supported in other locations besides the edges to move the spindle 25, and is not limited to being supported in the edges. This provides vertical motion in the direction of reference arrows B and C using both second linkage 105 and the third linkage 105′. It should be appreciated that the food processor 10 can be configured with blade platform 50 moving using only secondary linkage 105, for oscillatory, vertical motion, and third linkage 105 is optional. The secondary linkage system 210 forms no limitations to the food processor 10. It should also be appreciated that the food processor 10 may be configured with three or more linkages (not shown) with each connected to a different radial edge of the blade platform 50 and with each coupled to motor 60 by a linkage system for a controlled vertical motion. Again, the linkages are not limited to being supported on the radial edge of the blade platform 50, and various linkage to blade platform support configurations are envisioned. In yet a further embodiment, the apparatus may be formed with a single motor 55 instead of two motors 55, 60. The single motor 55 can be connected to a worm gear (not shown). The worm gear can be connected by a linkage to the single motor 55 for a spinning and reciprocating motion of the blades 35, 40. Various configurations are possible and within the scope of the present disclosure.

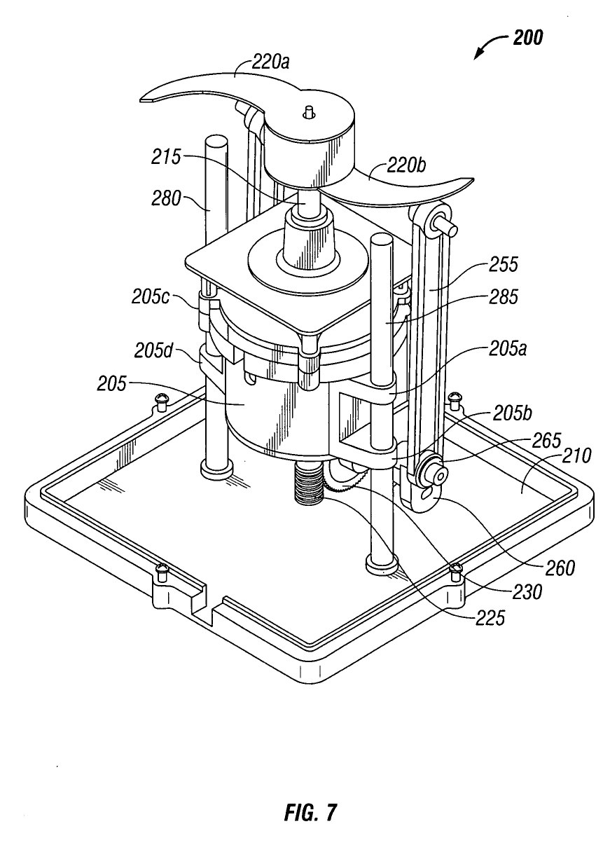

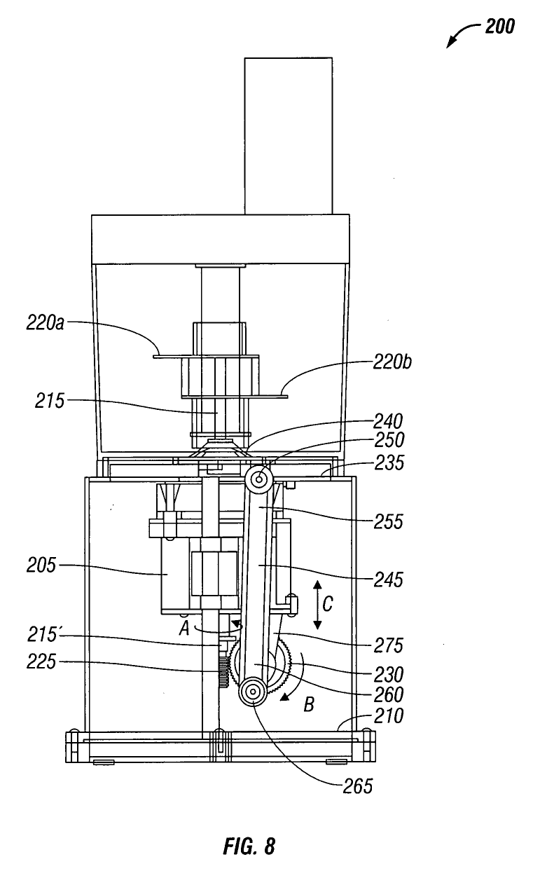

Turning now to FIG. 7, there is shown an additional embodiment according to the present disclosure of the apparatus 200. Preferably, the apparatus 200 also provides both chopping and grating in an oscillating advantageous manner. Apparatus 200 includes a motor 205 which moves in an upwardly and downwardly manner relative to a platform 210 (FIG. 8), which is removed in FIG. 7 for illustration purposes. Preferably, the motor 205 includes a drive shaft 215 that rotates and spins a pair of blades 220a, and 220b, as previously described.

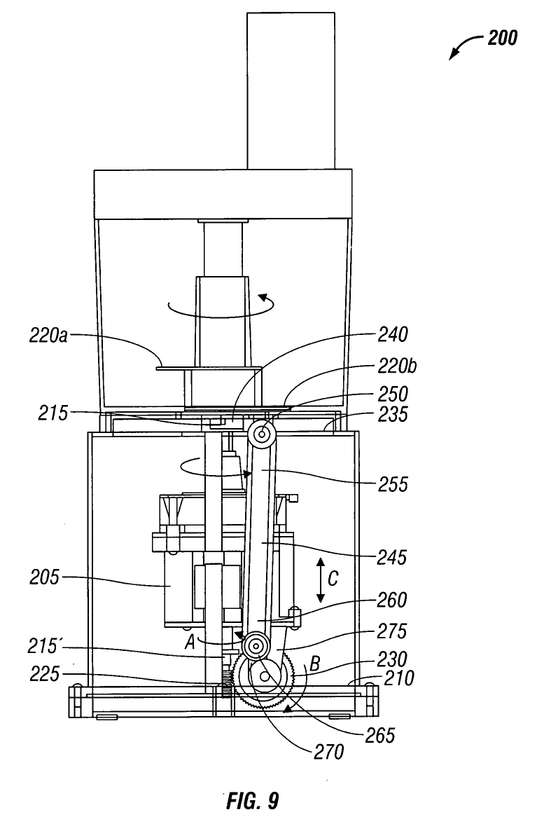

Turning now to the opposite end of the motor 205 shown as FIG. 8, the apparatus 200 includes a second drive shaft 215′ that extends from the motor 205 at a side that is opposite the drive shaft 215. The bottom or second drive shaft 215′ is surrounded in a coaxial arrangement by a worm gear 225. The worm gear 225 is preferably a cylindrical shaped gear that includes a spiral groove mounted thereon, which is connected over the second drive shaft 215′. Preferably, during rotation of the drive shaft 215′, the worm gear 225 will traverse in a direction upwardly and downwardly relative to the platform 210 as shown in FIG. 9.

This movement preferably is translated to move the entire motor 205 in a vertical manner. The motor's 205 vertical movement, will also move the drive shaft 215 that moves vertically the pair of blades 220a, and 220b to achieve an oscillating and rotating motion. Preferably, the motor 205 will cycle from between an upper limit and a lower limit, and repeat this vertical motion.

Preferably, in another embodiment, the motor 205 can be configured to only rotate, and then selectively move in a vertical manner to achieve the oscillating and rotating motion, when desired by the user. A switch, circuit, controller, or similar device may selectively actuate the rotation of the second drive shaft 215′. Alternatively, in yet another embodiment, the motor 205 can be configured to rotate together with the vertical motion at all times.

Preferably, the apparatus 200 also includes a gear 230 with a number of teeth that engages worm gear 225. During rotation of the worm gear 225, gear 230 will move in a similar manner, or cycle from between an upward motion, and a downward motion about the cam surface 265. Turning now to FIG. 9, there is shown a side view of the apparatus 200 according to the present disclosure.

The apparatus 200 also includes a blade platform 235. The blade platform 235, in this embodiment, is stationary and does not move. Preferably, the motor 205 includes the drive shaft 215 with a pair of blades 220a, 220b that extends over the blade platform 235. Preferably, the blade platform 235 includes an aperture 240 (FIG. 8), and the drive shaft 215 extends through the aperture 240 to connect with the motor 205 while the remainder of the aperture 240 is sealed to prevent contents from falling therethrough.

Preferably, a first link 245 is connected to blade platform 235 by a first pin 250 at a first end 255. First link 245 also includes an opposite second end 260. Preferably, the first link 245 also remains stationary during the upward and downward motion of the motor 205. Second end 260 of the first link 245 forms a camming surface 265, and the gear 230 preferably rotates about the camming surface 265 to translate the rotation of the worm gear 225 to the motor 205.

Gear 230 preferably includes a second link 270 (shown in FIG. 9) and a third link 275. The second link 270 preferably connects the gear 230 to the camming surface 265. The third link 275 preferably connects the gear 230 to the motor 205.

Preferably, in operation, the worm gear 225 will rotate in a counter clockwise manner shown by reference arrow A. The worm gear 225, thus, will rotate gear 230 in a first rotational manner. Preferably, the camming surface 265 is generally fixed relative to the gear 230, and the gear 230 is also connected to the motor 205 by third link 275. In operation, the gear 230 will rotate about the camming surface 265 as shown by reference arrow B. The gear 230 communicates with the motor 205 via the third link 275, and during rotation will drive the motor 205 in a cyclic manner or in a direction upwardly, or downwardly as shown in FIGS. 8, and 9 by reference arrow C.

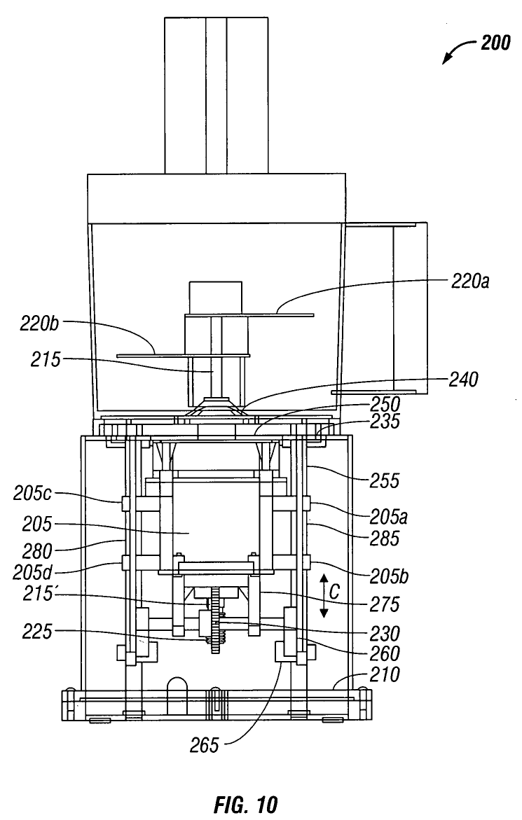

As shown in FIG. 10, the motor 205 may be connected along a first guide post 280 and a second guide post 285 by a first pair of loops 205a, 205b and a second pair of loops 205c, 205d. Preferably, the motor 205 is guided in an upward, and downward manner by the posts 280, and 285 to correctly orient the motor 205, and vertically move the drive shaft 215. In this manner, an oscillatory, and rotational movement of the blades 220a, 220b is achieved.

While this invention has been particularly shown and described with references to example embodiments thereof, it will be understood by those skilled in the art that various changes in form and details may be made therein without departing from the scope of the invention encompassed by the appended claims.

What is claimed is:

1. An appliance comprising:
a primary motor configured to rotate a blade connected to a spindle, the blade and the spindle being disposed on a blade platform, the primary motor mounted on a second platform; and
a second motor configured to translate the blade platform and the spindle by a first linkage from a first position to a second position relative to the second platform.

2. The appliance of claim 1, wherein the first motor and the second motor are independent.

3. The appliance of claim 1, further comprising a first output shaft connected to the spindle, the spindle being connected to a spindle head, the spindle head configured to rotate a plurality of blades, the first output shaft being connected to the primary motor.

4. The appliance of claim 1, wherein the blade platform includes an aperture, wherein the spindle is positioned through the aperture and configured to rotate the blade above the blade platform.

5. The appliance of claim 1, wherein the second motor includes an output shaft, the output shaft being connected to a geared arrangement to move the first linkage in a longitudinal manner.

6. The appliance of claim 5, wherein the first linkage comprises a rocker arm having a first end configured to rotate and a second lever end configured to longitudinally reciprocate between an elevated and a lowered position.

7. The appliance of claim 6, wherein the second lever end is connected to the first linkage and the first linkage is connected to the blade platform by a pin.

8. The appliance of claim 7, further comprising a container disposed above the second platform.

9. The appliance of claim 1, further comprising a plurality of blades.

10. The appliance of claim 5, wherein the geared arrangement comprises a first gear including a plurality of teeth connected to a second gear, the second gear further configured to reciprocate the first linkage from the first position to the second position by reciprocating a rocker arm.

11. The appliance of claim 10, wherein the second gear is connected to a first cam, the first cam connected to a first end of an intermediate linkage to rotate the first end, the intermediate linkage including a second end, the second end being opposite the first end, the second end of the intermediate linkage being configured to move the rocker arm in a longitudinal manner in response to the rotation.

12. An appliance comprising:
a primary motor configured to rotate a blade disposed above a first platform, the primary motor being stationary and connected to a second stationary platform, the first platform disposed above the second platform; and
a second motor independent of the primary motor, the second motor operatively connected to the first platform by a first linkage connected to a rocker arm, the second motor operating to move the rocker arm connected to the first linkage, the rocker arm moving the first linkage in response to the rotation, the rocker arm reciprocating the first platform relative to the second platform from a first elevated position to a second lowered position.

13. The appliance of claim 12, wherein the second motor includes an output shaft, the output shaft being connected to a sun gear, the sun gear connected to a planet gear, the sun gear rotating the planet gear to rotate a first cam, the first cam being connected to a second linkage, the second linkage rotating the rocker arm.

14. The appliance of claim 13, wherein the first linkage includes a second end connected to a pivot, the pivot being connected to the first platform, wherein the rotation of a first end of the first linkage connected to the rocker arm reciprocates the second end in a longitudinal manner to elevate and lower the first platform relative to the second platform.

15. The appliance of claim 12, wherein the blade is supported on a spindle, the spindle extending through an aperture in the first platform, the spindle being moveable and rotatable with the first platform.

16. The appliance of claim 12, wherein the primary motor rotates a plurality of blades.

17. The appliance of claim 12, further comprising a container adapted to rest suspended above the first platform.

18. An appliance comprising:
a primary motor configured to rotate a blade disposed above a first platform, the primary motor being stationary and connected to a second platform, the first platform being above the second platform; and
a second motor independent of the primary motor, the second motor operatively connected to the first platform by a first linkage, the primary motor rotating the blade disposed above the first platform, the second motor operating to rotate a second linkage connected to the first linkage, the first linkage in response to the rotation configured to reciprocate the first platform relative to the stationary second platform between a first elevated position and a second lowered position.

19. An appliance comprising:
a first motor including a first output shaft connected to a spindle, the spindle being connected to a spindle head, the spindle head configured to rotate a plurality of blades;
a blade platform including an aperture, the spindle extending above the aperture and configured to rotate the plurality of blades above the blade platform;
a second motor being stationary and connected to a second platform, the second platform being positioned under the blade platform, the second motor including a second output shaft, the second output shaft being connected to a first gear, the first gear being rotatably connected to a second gear, the second gear being connected to a first cam, the first cam operatively connected to a first linkage at a first end, the first linkage being connected to a rocker arm;
the second motor operating to rotate the second output shaft and to rotate the first gear, the first gear rotating the second gear, the second gear rotating the first linkage, the first linkage rotating the rocker arm, the rocker arm connected to a second linkage; and
the second linkage having a first end and a second end, the first end in response to the rotation moving the second end in a longitudinal direction, the second linkage being connected to the blade platform at the second end and configured to reciprocate the blade platform in a longitudinal manner relative to the second platform between a first position and a second position.

20. The apparatus of claim 19, further comprising a post connected on the second platform and disposed through the blade platform, the post orienting the blade platform during movement of the blade platform from the first position to the second position.

21. The apparatus of claim 20, wherein the post supports a container.

22. The apparatus of claim 19, further comprising a secondary linkage connected to the blade platform on an opposite side and configured to translate the blade platform from the first position to the second position.

23. An appliance comprising:
a motor configured to rotate a blade disposed above a first platform, the motor including a first rotatable shaft and a second rotatable shaft extending opposite the first rotatable shaft;
a blade connected to the first rotatable shaft;
a worm gear disposed over the second rotatable shaft;
a gear engaging the worm gear;
a cam connected to the gear;
a first linkage connecting the cam to the first platform; and
the motor rotating the worm gear, and the worm gear rotating the gear, the gear configured to rotate about the cam, and the gear moving a second linkage, the second linkage moving the motor to translate the blade upwardly and downwardly.

24. The appliance of claim 23, where the second linkage moves the motor to translate the blade upwardly and downwardly in a cyclic manner.

25. The appliance of claim 24, wherein the motor is moved in the cyclic manner based on the rotation of the worm gear.

26. The appliance of claim 23, further comprising a post connected to a stationary platform, and configured to guide the motor.

27. The appliance of claim 26, further comprising a loop connected to the motor, the loop engaging the post.

28. The appliance of claim 23, further comprising a plurality of posts connected to a stationary platform, and further comprising a plurality of loops connected to the motor, the plurality of loops engaging the plurality of posts for guiding the motor.

29. The appliance of claim 23, further comprising a plurality of blades connected to the first rotatable shaft.

30. The appliance of claim 23, wherein the cam is connected to the gear by a third linkage.

31. The appliance of claim 30, wherein the cam is an end of the first linkage, and wherein the cam connects to the third linkage by a pin.

32. The appliance of claim 23, wherein the first linkage is connected to the first platform by a pin.

33. The appliance of claim 23, wherein the worm gear disposed over the second rotatable shaft includes a spiral shaped groove that engages with a plurality of teeth of the gear.

34. The appliance of claim 23, wherein the first linkage connecting the cam to the first platform comprises a bar-like resilient member.

35. The appliance of claim 23, further comprising a housing and a container connected to the housing, wherein the blade extends into the container for processing food.

36. The appliance of claim 23, wherein the motor rotates the worm gear in a first rotational direction, and the worm gear rotates the gear, the gear configured to rotate about the cam in a second rotational direction, and the gear moving the second linkage in a vertical manner.

37. The appliance of claim 23, wherein the first rotatable shaft extends from a top or bottom of the motor, and wherein the second rotatable shaft extends from an opposite side of the motor.

38. The appliance of claim 23, wherein the first rotatable shaft extends above the first platform through a sealed aperture.

39. The appliance of claim 23, wherein the worm gear is disposed in a generally coaxial manner on or over the second rotatable shaft.

40. An appliance comprising:
a movable motor configured to rotate a blade disposed above a first platform, the motor including a first rotatable shaft and a second rotatable shaft extending opposite the first rotatable shaft;
a blade connected to the first rotatable shaft;
a worm gear disposed coaxially over the second rotatable shaft;
a gear engaging the worm gear;
a cam surface connected to the gear by a first link;
the cam surface including a second link connecting the cam surface to the first platform so the cam surface remains stationary relative to the moveable motor; and
the motor rotating the worm gear, and rotating the gear, the gear configured to rotate about the cam surface, and the gear moving a third link connected to the motor, the third link moving the motor to translate the blade upwardly and downwardly based on the rotation of the worm gear.

41. The appliance of claim 40, further comprising a post connected to a stationary platform, and wherein the post is configured to guide the motor.

42. A method of moving a blade in a cyclic and rotating manner, the method comprising:
rotating a blade on a first rotating shaft coupled to a motor; and
translating rotation from a second rotating shaft to move the motor vertically, and in the cyclic manner.
